(19) United States
(12) Patent Application Publication
(10) Pub. No.: US 2011/0000563 A1
(43) Pub. Date: Jan. 6, 2011

(54) FLOW RATE CONTROL APPARATUS

(76) Inventors: Takayuki Ito, Tokyo (JP); Mutsumi Muto, Tokyo (JP)

Correspondence Address: BIRCH STEWART KOLASCH & BIRCH, PO BOX 747, FALLS CHURCH, VA, 22040-0747, US

(21) Appl. No.: 12/521,693

(22) PCT Filed: Nov. 2, 2007
(86) PCT No.: PCT/JP2007/071411

§ 371 Date: Jun. 29, 2009

(30) Foreign Application Priority Data
Jan. 24, 2007 (JP) 2007-014033

(51) Int. Cl. F16K 31/02

(52) U.S. Cl. 137/596.17

(57) ABSTRACT

A communication section located within a piping section and communicating with a common first port introducing/exhausting fluid is formed such that the diameter of the communication section is larger than the inner diameter of a valve-opening/closing passage by passing the communication section through the piping section from the external, further including a lid sealing the through hole.

### TECHNICAL FIELD

The present invention relates to a flow rate control apparatus controlling a flow rate of fluid.

### BACKGROUND ART

With an increase of demand in tightening of exhaust gas regulations, in order to increase the capacity to dispose of evaporated gas evaporated from a fuel tank, there has arisen the need to increase a flow rate controlled by a solenoid valve for purging gas provided between a canister and an engine. Therefore, some conventional flow rate control apparatuses have increased a flow rate to be controlled by enlarging a solenoid valve itself. Further, there are some examples where two solenoid valves are connected in the different technical field (see Patent Document 1, for example).

Patent Document 1: JP-A-2004-266658

The conventional flow rate control system is arranged as mentioned above, and in a flow rate control system where its solenoid valve itself is enlarged, the diameter of a valve mechanism composed of a valve and a valve seat is also increased. Thus, there is a problem that precise control of gas flow cannot be performed. Moreover, it is necessary to redesign a flow rate control apparatus as the size of its solenoid valve increases, and thus there is a problem that the production cost thereof increases. Furthermore, when a flow rate is increased by connecting two solenoid valves, there arises a problem that, if a three way port is used for the connection, the connection correspondingly increases the size of the apparatus. Besides, there is a problem that an increase in the length of a passage through which evaporated gas flows increases the pressure loss caused therethrough.

An object of the present invention is to provide a flow rate control apparatus which has a structure for restraining a pressure loss from increasing, and increases the flow rate of fluid.

### DISCLOSURE OF THE INVENTION

The flow rate control apparatus according to the present invention is characterized in that a communication section located within a piping section and communicating with a common first port introducing/exhausting fluid is formed in such a manner that the diameter of the communication section is larger than the inner diameter of a valve-opening/closing passage by passing the communication section through the piping section from the external, and also includes a lid sealing the through hole.

According to the present invention, the flow rate control apparatus has a structure for restraining a pressure loss from increasing, thus increasing greatly a flow rate to be controlled, since the communication section located within the piping section and communicating with the common first port introducing/exhausting fluid is formed in such a manner that the diameter of the communication section is larger than the inner diameter of the valve-opening/closing passage by means of passing the communication section through the piping section from the external and including the lid sealing the through hole.

### BRIEF DESCRIPTION OF THE DRAWINGS

FIG. 1 is a view showing an example of an arrangement of a flow rate control apparatus according to the first embodiment.

FIG. 2 is a sectional view showing an example of an arrangement of the flow rate control apparatus according to the first embodiment.

FIG. 3 is an enlarged sectional view of a valve mechanism according to the first embodiment.

FIG. 4 is an enlarged sectional view of the vicinity of a communication section A of a piping section formed by conventional resin molding.

FIG. 5 is an enlarged sectional view of the vicinity of a communication section A of a piping section according to the first embodiment.

FIG. 6 is a view showing an example of an arrangement of a flow rate control apparatus according to the second embodiment.

FIG. 7 is a sectional view showing an example of an arrangement of the flow rate control apparatus according to the second embodiment.

FIG. 8 is a sectional view showing an example of an arrangement of a flow rate control apparatus according to the third embodiment.

FIG. 9 is a sectional view showing an example of an arrangement of a flow rate control apparatus according to the fourth embodiment.

FIG. 10 is a view showing an example of an arrangement of a flow rate control apparatus according to the fifth embodiment.

### BEST MODE FOR CARRYING OUT THE INVENTION

Embodiments of the present invention will now be described with reference to the accompanying drawings in order to explain the present invention in more detail.

### First Embodiment

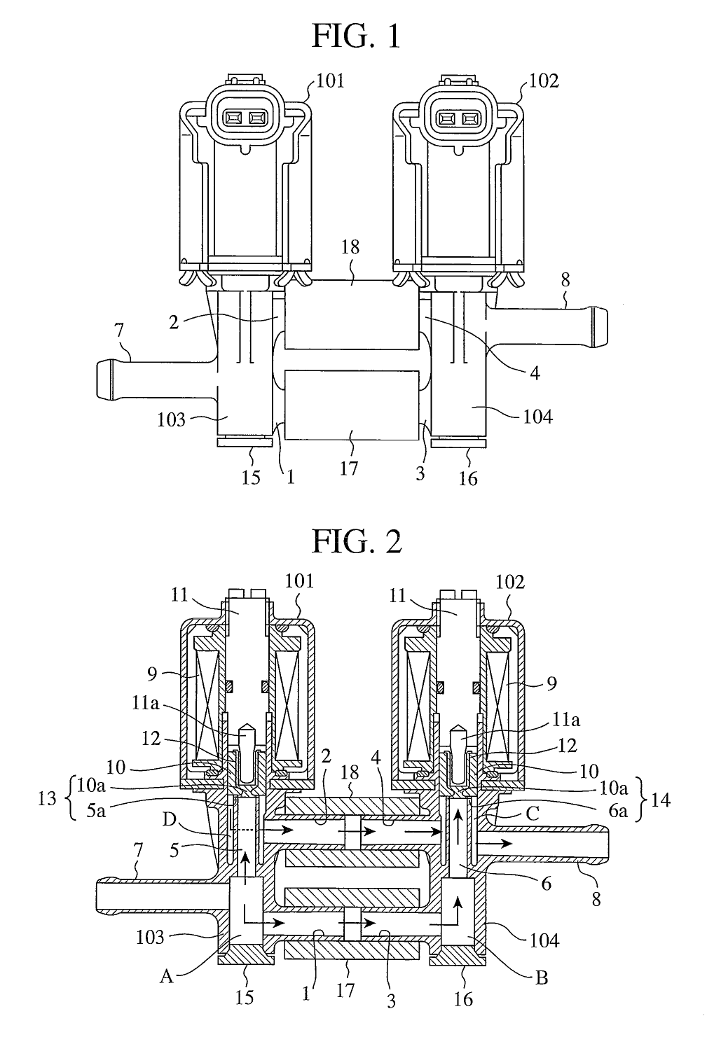

FIG. 1 is a view showing an example of an arrangement of a flow rate control apparatus according to the first embodiment. In the first embodiment, an explanation is given of a case, as an example, where the flow rate control apparatus is applied to a purge solenoid valve which is interposed in an evaporated gas introducing passage connecting a canister collecting evaporated gas generated in a fuel tank of a vehicle or the like with an engine of the vehicle, thus controlling the flow rate of the evaporated gas.

The flow rate control apparatus according to the first embodiment is composed of solenoid sections 101, 102 controlling the flow rate of evaporated gas. The solenoid section 101 has assembled thereto a piping section 103 made of resin, including a common port 7 (common first port) introducing evaporated gas from a fuel tank, ports 1, 2 (a first port and a second port) exhausting the evaporated gas introduced through the common port 7, and a lid 15. The solenoid section 102 has assembled thereto a piping section 104 made of a resin, including a port 3 (a third port) introducing the evaporated gas exhausted through the port 1, a port 4 (a fourth port) introducing the evaporated gas exhausted through the port 2, a common port 8 (a common second port) exhausting the evaporated gas introduced through the port 3 and the port 4, and a lid 16. The port 1 and port 3 are connected with a rubber hose 17, and the port 2 and port 4 are connected with a rubber hose 18.

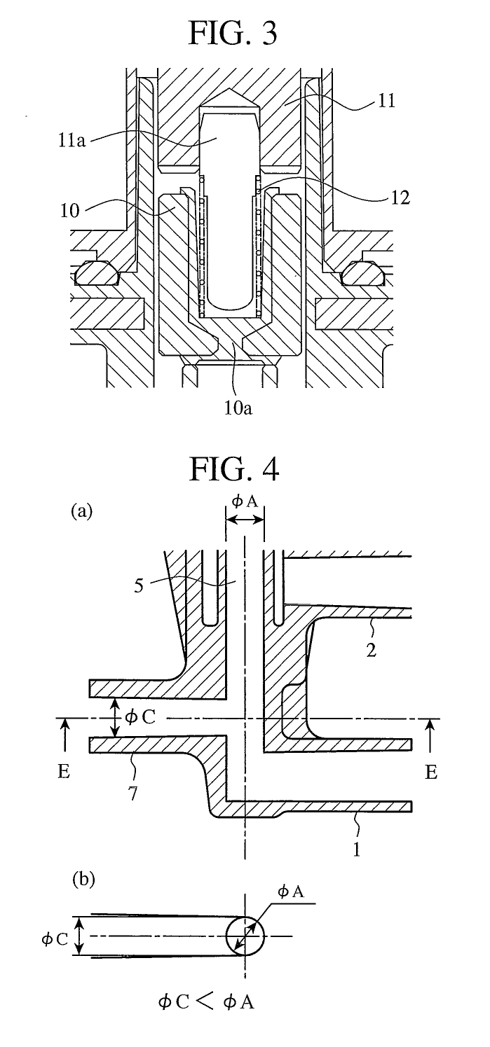

FIG. 2 is a sectional view of the flow rate control apparatus according to the first embodiment. FIG. 3 is an enlarged sectional view of a valve mechanism according to the first embodiment. The solenoid section 101 and the solenoid section 102 each include a coil 9 generating a magnetic field with the voltage applied from an external system; a plunger 10 consisting of a magnetic body, having a valve section 10a at one end, and making a linear motion in the direction of a valve stem by the magnetic field generated by the coil 9; a spring 12 exerting an energizing force in a closing direction of the valve on the plunger 10; a guide member 11a provided in a protruding condition in the direction of the valve stem and holding the spring 12; and a core 11.

The piping section 103 includes a common port 7 introducing evaporated gas; a valve-opening/closing passage 5 which communicates with the common port 7 on one-end side and has, on the other-end side, a valve seat 5a intercepting the flow of the evaporated gas by abutting against the valve section 10a of the plunger 10 of the solenoid section 101; a large diameter passage D formed around the outer periphery of the valve-opening/closing passage 5, which communicates with the valve-opening/closing passage 5 by valve opening of a valve mechanism 13; the port 1 which directly communicates with the valve-opening/closing passage 5; the port 2 which directly communicates with the large diameter passage D; a communication section A between the common port 7, the valve-opening/closing passage 5, and the port 1; and a lid 15 sealing or closing a hole formed when the communication section A penetrates the piping section 103 from externally of the piping section. The valve mechanism 13 consists of the valve section 10a of the solenoid section 101 and the valve seat 5a of the piping section 103.

The piping section 104 includes the port 3 connected with the port 1; the port 4 connected with the port 2; a valve-opening/closing passage 6 which communicates with the port 3 on one-end side and has, on the other-end side, a valve seat 6a intercepting the flow of the evaporated gas by abutting against the valve section 10a of the plunger 10 of the solenoid section 102; a large diameter passage C formed around the outer periphery of the valve-opening/closing passage 6, which communicates with the valve-opening/closing passage 6 by the opening of a valve of a valve mechanism 14; a common port 8 exhausting the evaporated gas by directly communicating with the large diameter passage C; a communication section B between the port 3 and the valve-opening/closing passage 6; and a lid 16 closing a hole formed when the communication section B penetrates the piping section 104 from externally of the piping section. Further, the arrows of the figure indicate the flow of the evaporated gas. The valve mechanism 14 is composed of the valve section 10a of the solenoid section 102 and the valve seat 6a of the piping section 104.

FIG. 4 (a) is an enlarged sectional view indicating the vicinity of the communication section A of a piping section formed by conventional resin molding, and FIG. 4 (b) is a partial sectional view taken along line E-E of FIG. 4 (a). When two solenoid valves are connected, in order for evaporated gas to be fully introduced into the valve mechanisms 13, 14 of the respective solenoid valves, it is necessary to enlarge the internal diameter of the common port 7. However, since in the conventional piping section, the valve-opening/closing passage 5 is formed by inserting a pin for resin molding therein, in performing resin molding, from the side where the solenoid section 101 is mounted, the internal diameter φA of the valve-opening/closing passage 5 is limited to the size of the valve mechanism 13 and the internal diameter thereof cannot be enlarged. Moreover, the internal diameter φC of the common port 7 is limited to the internal diameter φA of the valve-opening/closing passage 5, and thus the internal diameter φC thereof cannot be formed larger than the internal diameter φA of the valve-opening/closing passage 5. Therefore, there is a problem that evaporated gas cannot be supplied with sufficient quantity to the valve mechanisms 13, 14.

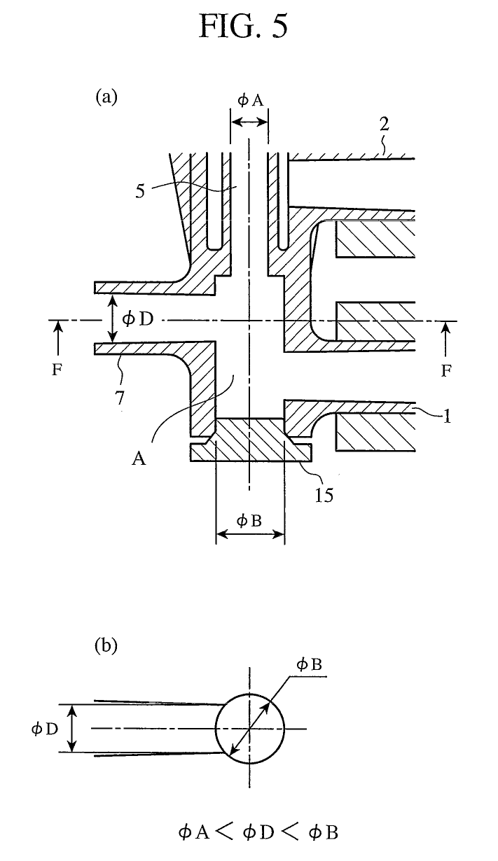

FIG. 5 (a) is an enlarged sectional view of the vicinity of the communication section A indicated in FIG. 2, and FIG. 5 (b) is a partial sectional view taken along line F-F of FIG. 5 (a). In the first embodiment, upon resin-molding of the piping section 103, the internal diameter φB of the communication section A is enlarged by inserting a pin for resin molding therein, which has a diameter φB larger than the internal diameter φA of the valve-opening/closing passage 5, from the side opposite from the valve-opening/closing passage 5 along the direction of the valve stem and performing the resin molding. Further, evaporated gas is prevented from being externally exhausted by sealing with the lid 15 a hole formed through the piping section 103 on the side opposite from the valve-opening/closing passage 5. Moreover, the internal diameter φD of the common port 7 is made with a size larger than the internal diameter φA of the valve-opening/closing passage 5 by enlarging the internal diameter φD of the common port 7 so as to correspond to the internal diameter φB of the communication section A. Furthermore, in the first embodiment, the common port 8 is molded with a large size so that the internal diameter thereof will correspond to the internal diameter φD of the common port 7, and also the internal diameter of the communication section B of the piping section 104 is made larger by a method similar thereto. In this connection, the internal diameter of the large diameter passage C formed around the outer peripheral surface of the valve-opening/closing passage 6 is primarily large, and thus it is possible to make larger the internal diameter of the common port 8 without carrying out a process similar to that used for the communication section A.

The operation of the flow rate control apparatus according to the first embodiment will next be discussed.

When a voltage is applied to the coil 9 from an external system, a magnetic field is generated. When an electromagnetic force larger than the energizing force in a closing direction of the valve by the spring 12 is generated in the magnetic field, the plunger 10 makes a linear motion in an opening direction of the valve, and abuts against the guide member 11a to stop. Further, the flow rate of evaporated gas can be controlled by changing the valve opening period of the valve mechanisms 13, 14. It should be appreciated that the flow rate control of the evaporated gas may be performed by simultaneously controlling both of the valve mechanisms 13, 14 or controlling them one after another; however, controlling the mechanisms one after the other enables a minute flow rate to be more precisely controlled.

The flow of evaporated gas will next be discussed.

When evaporated gas is introduced through the common port 7, the gas is divided, through the communication section A, into a portion introduced into the valve mechanism 13 through the valve-opening/closing passage 5 and a portion exhausted directly to the port 3 of the piping section 104 through the port 1. The evaporated gas led to the valve mechanism 13 passes through the clearance between the valve section 10a and the valve seat 5a constituting the valve mechanism 13, which is formed by a translatory movement of the plunger 10 in an opening direction of the valve, which is made by applying a voltage to the coil 9, and the gas is introduced into the port 4 through the port 2 via the large diameter passage D. Moreover, the evaporated gas introduced into the port 3 is introduced into the valve mechanism 14 through the communication section B and the valve-opening/closing passage 6, further passes through the clearance between the valve section 10a and the valve seat 6a constituting the valve mechanism 14, which is formed by the translatory movement of the plunger 10 in an opening direction of the valve, which is made by applying a voltage to the coil 9, further merges with the evaporated gas introduced through the port 4 in the large diameter passage C, and then is exhausted through the common port 8. In this connection, the internal diameter of the large diameter passage C formed around the outer peripheral surface of the valve-opening/closing passage 6 is primarily large, and thus no pressure loss is made even when the evaporated gases merge with each other in the large diameter passage C.

As described above, according to the first embodiment, the internal diameter φB of the communication section A can be made larger than the internal diameter φA of the valve-opening/closing passage 5, by inserting a pin for resin molding, upon resin molding of the piping section 103, the pin having an external diameter φB larger than the internal diameter φA of the valve-opening/closing passage 5, from the side opposite from the valve-opening/closing passage 5 along the direction of the valve stem, and performing the resin molding thereof. Further, since the internal diameter φD of the common port 7 is made larger than the internal diameter φA of the valve-opening/closing passage 5 and a hole formed through the piping section 103 on the side opposite from the valve-opening/closing passage 5 is closed with a lid 15, the increase of pressure loss can be suppressed and the evaporated gas can be supplied with sufficient quantity into the valve mechanisms 13, 14. Moreover, the common port 8 is molded in a large size so that the internal diameter thereof can correspond to the internal diameter φD of the common port 7, and thus the evaporated gas introduced into the flow rate control apparatus is smoothly exhausted through the common port 8. Furthermore, the internal diameter of the communication section B is made large, similarly to the communication section A, and thus the increase of pressure loss can be suppressed through the communication section B.

Besides, components constituting the flow rate control apparatus are connected such that the length of the path of the evaporated gas introduced through the common port 7 and exhausted through the common port 8 by way of the valve mechanism 13 is equal to the length of the path of the evaporated gas introduced through the common port 7 and exhausted through the common port 8 via the valve mechanism 14, and further, the two passages of the evaporated gas composed of the port 1 and port 3, and the port 2 and port 4 have a straight shape. Thus, the pressure loss caused by the entire flow rate control apparatus can be kept to a minimum. Further, conventional solenoids are employed for the solenoid sections 101, 102, and thus it is not necessary to redesign the entire solenoid valves; the production cost thereof can be kept low correspondingly.

Moreover, in the first embodiment, it is also possible to introduce evaporated gas through the common port 8 and exhaust the gas through the common port 7. In the case, the evaporated gas is divided through the large diameter passage C, and the divided evaporated gases are merged in the communication section A. The flow of the evaporated gas will next be discussed.

When the evaporated gas is introduced through the common port 8, the gas is divided, through the communication section C, into one part introduced into the valve mechanism 14 and the other part exhausted to the port 2 of the piping section 103 through the port 4. The evaporated gas led to the valve mechanism 14 is introduced into the port 1 through the port 3 via the valve-opening/closing passage 6 and the communication section B by the clearance between the valve section 10a and the valve seat 6a constituting the valve mechanism 14, which is formed by the translatory movement of the plunger 10 in an opening direction of the valve, which is made by applying a voltage to the coil 9. Furthermore, the evaporated gas introduced into the port 2 is introduced into the valve mechanism 13 through the large diameter passage D, further merges with the evaporated gas in the communication section A, which is introduced through the port 1 via the valve-opening/closing passage 5 by the clearance between the valve section 10a and the valve seat 5a constituting the valve mechanism 13, which is formed by the translatory movement of the plunger 10 in an opening direction of the valve, which is made by applying a voltage to the coil 9, and then is exhausted through the common port 7. Note that even if the evaporated gas reversely flows, the internal diameters of both the communication section A and large diameter passage C are large, and thus no pressure loss is caused through the communication section A and the large diameter passage C.

### Second Embodiment

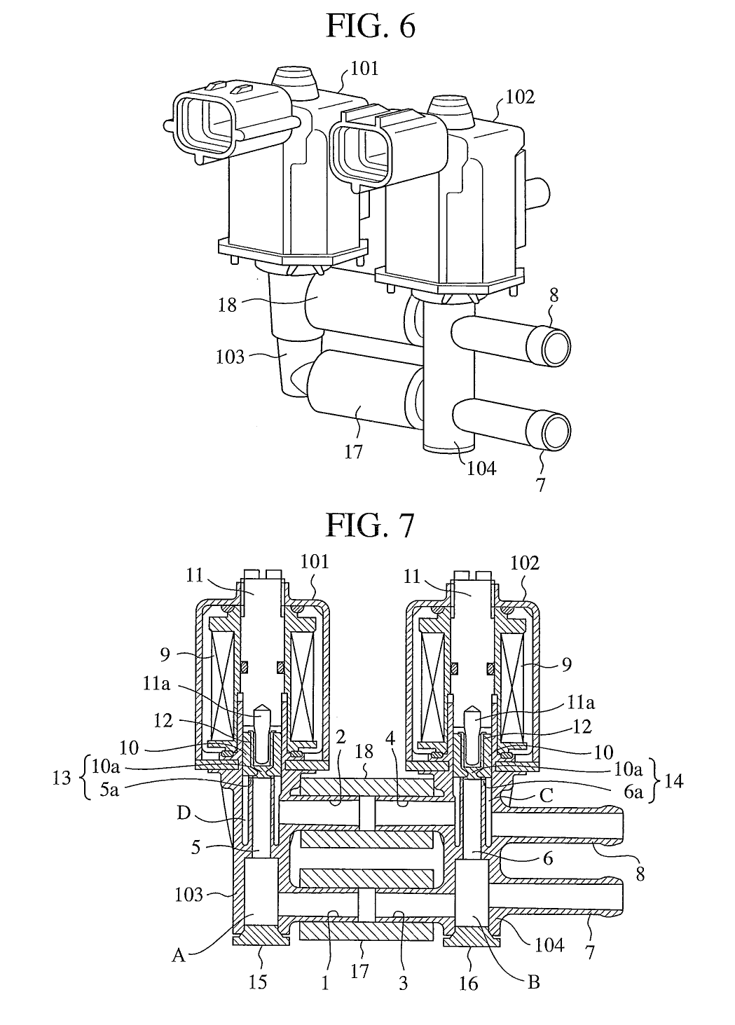

FIG. 6 is a view showing an example of an arrangement of a flow rate control apparatus according to the second embodiment, and FIG. 7 is a sectional view of the flow rate control apparatus according to the second embodiment. The parts similar to those described in the first embodiment are designated by similar numerals, and these repetitive explanations will be omitted. The second embodiment is characterized in that a common port 7 and a common port 8 are provided on the side of the piping section 104. Such arrangement eliminates the need for providing a common port 7 on the side of the piping section 103, enables a conventional piping section to be used as the piping section 103, and enables the corresponding reduction of the production cost thereof. When the inner diameter of the communication section A is made large, however, as indicated in FIG. 7 as with the first embodiment, the arrangement can reduce the pressure loss made by the communication section A. It should be noted that the common port 7 and common port 8 may be provided on the side of the piping section 103. Other effects are similar to those of the first embodiment.

### Third Embodiment

FIG. 8 is a view showing an example of an arrangement of a flow rate control apparatus according to the third embodiment. The parts similar to those described in the first embodiment are designated by similar numerals, and these repetitive explanations will be omitted. In the third embodiment, the ports 1, 2 are provided with grooves 21, 22 fitting O rings 19, 20, respectively. Furthermore, the ports 3, 4 are provided with wide diameter end sections 23, 24 covering the outer peripheral surfaces of the O rings 19, 20 and fitting around the end sections of the ports 1, 2, respectively. The O rings 19, 20 are fitted in the grooves 21, 22, respectively, and then the port 1 is connected with the port 3 and the port 2 is connected with the port 4, respectively. According to the third embodiment, the need for the process of assembling the rubber hoses 17, 18 thereto is eliminated, and it is essential only that the port 1 be connected with the port 3 and the port 2 be connected with the port 4 after fitting the O rings 19, 20 in the grooves 21, 22, respectively. Thus, the number of processes can be reduced to keep low the production cost thereof. Other effects are similar to those of the first embodiment. In this context, it may be arranged that the ports 3, 4 be provided with the grooves 21, 22, the ports 1, 2 be provided with wide diameter end sections 23, 24, respectively, and the port 1 be connected with the port 3 and the port 2 be connected with the port 4, respectively.

### Fourth Embodiment

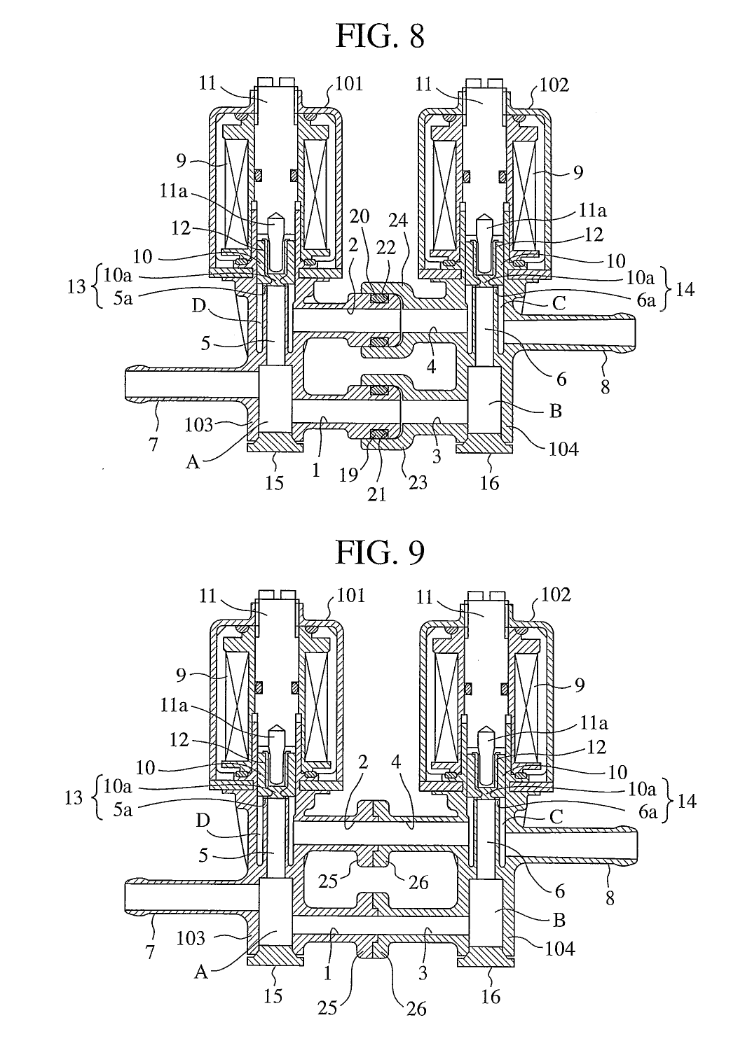

FIG. 9 is a view showing an example of an arrangement of a flow rate control apparatus according to the fourth embodiment. The parts similar to those described in the first embodiment are designated by similar numerals, and these repetitive explanations will be omitted. In the fourth embodiment, the end portions of the ports 1, 2 are provided with flanges 25, and the end portions of the ports 3, 4 are provided with flanges 26, respectively. Further, the flange 25 of the port 1 and the flange 26 of the port 3, and the flange 25 of the port 2 and the flange 26 of the port 4 are butted end-to-end, respectively, and connected by ultrasonic wave welding or laser welding. According to the fourth embodiment, since the rubber hoses 17, 18 are not eliminated in the above, leakage of the evaporated gas at the connection sections between the rubber hose 17, port 1, and port 3, and between the rubber hose 18, port 2, and port 4, transmission of the evaporated gas from the rubber hoses 17, 18 themselves, and so on can be prevented. Moreover, other effects are similar to those of the first embodiment.

### Fifth Embodiment

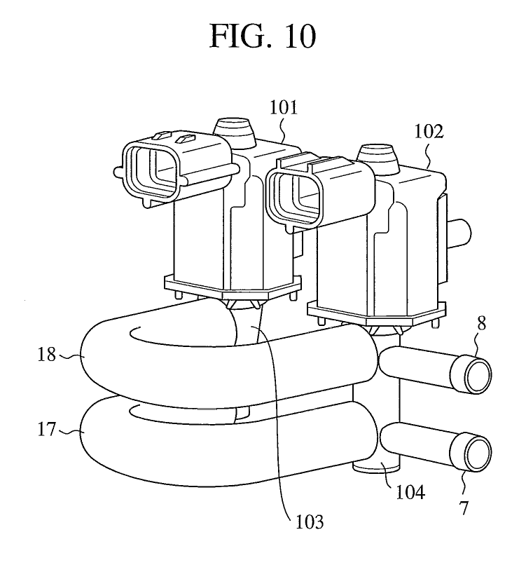

FIG. 10 is a view showing an example of an arrangement of a flow rate control apparatus according to the fifth embodiment. The parts similar to those described in the first embodiment are designated by similar numerals, and these repetitive explanations will be omitted. In the fifth embodiment, the port 1 and port 3, and the port 2 and port 4 are connected with U-shaped rubber hoses 17, 18, respectively. According to the fifth embodiment, it is possible to dispose the solenoid valves close to each other, and it is possible to reduce the size of the overall flow rate control apparatus. Other effects are similar to those of the first embodiment. In this connection, the shape of the rubber hose is not limited to a U-shape, and the shape may be a Π-shape or the like.

In the first to fifth embodiments, though the flow rate control apparatus is described with flow rate control apparatuses where two solenoid valves are connected by way of examples, three or more solenoid valves may be connected instead. In the case, the fabrication of a flow rate control apparatus can be achieved by interposing a solenoid valve including a piping section having a port connected with the port 1, a port connected with the port 2, a port connected with the port 3, and a port connected with the port 4 between a solenoid valve consisting of the solenoid section 101 and the piping section 103, and a solenoid valve consisting of the solenoid section 102 and the piping section 104. A thus arranged flow rate control apparatus can further increase the flow rate of evaporated gas to be controlled. Furthermore, the flow rate control apparatus can be applied not only to the control of the flow rate of evaporated gas but also to the control of the flow rate of other fluids.

Moreover, in the first to third embodiments and the fifth embodiment, connection sections between pipes can be prevented from being disconnected from an apparatus without use of clips for fixing pipes or the like by securing solenoid valves to the same bracket or the like. Besides, the present invention may be carried out in practice by combining the first, second, and third embodiments, the first, second, and fourth embodiments, or the first, second, and fifth embodiments. In those cases, the effect of each of the combined embodiments can be obtained.

### INDUSTRIAL APPLICABILITY

As mentioned above, the flow rate control apparatus according to the present invention is suitable, e.g., for a flow rate control apparatus for controlling the flow rate of evaporated gas evaporated from a fuel tank because the flow rate control apparatus of the invention permits a flow rate to be controlled to be greatly increased by forming a communication section within a piping section, which communicates with a common first port introducing/exhausting fluid, such that the diameter of the communication section is larger than the inner diameter of a valve-opening/closing passage.

1. A flow rate control apparatus comprising:
a first piping section forming therein a common first port introducing and exhausting fluid, a valve-opening/closing passage communicating with the common first port on one end side and opened and closed by a valve on the other end side, a first large diameter passage formed on the outer periphery of the valve-opening/closing passage, and communicating with the valve-opening/closing passage by opening of the valve, a first port directly communicating with the valve-opening/closing passage, and a second port directly communicating with the first large diameter passage;
a first solenoid valve having assembled to the first piping section a first driving force generating section generating driving force for opening and closing the valve;
a second piping section forming therein a third port connected with the first port, a fourth port connected with the second port, another valve-opening/closing passage communicating with the third port on one-end side and opened and closed by another valve on the other-end side, a second large diameter passage formed on the outer periphery of the latter valve-opening/closing passage, and directly communicating with the fourth port and communicating with the latter valve-opening/closing passage by opening of the latter valve, and a common second port introducing and exhausting fluid by directly communicating with the second large diameter passage; and
a second solenoid valve having assembled to the second piping section a second driving force generating section generating driving force for opening and closing the latter valve,
wherein a communication section between the common first port, the valve-opening/closing passage, and the first port in the first piping section is formed such that the diameter of the communication section is larger than the inner diameter of the valve-opening/closing passage by passing the communication section through the first piping section from the external; and
wherein the communication section includes a lid sealing a hole formed by the passing therethrough.

2. A flow rate control apparatus comprising:
a first piping section providing therein a common first port introducing and exhausting fluid, a valve-opening/closing passage communicating with the common first port on one end side and opened and closed by a valve on the other end side, a first large diameter passage formed on the outer periphery of the valve-opening/closing passage and communicating with the valve-opening/closing passage by opening of the valve, a third port directly communicating with the valve-opening/closing passage, a fourth port directly communicating with the first large diameter passage, and a common second port directly communicating with the first large diameter and introducing and exhausting fluid;
a first solenoid valve having assembled to the first piping section a first driving force generating section generating driving force for opening and closing the valve;
a second piping section forming therein a first port connected with the third port, a second port connected with the fourth port, another valve-opening/closing passage communicating with the first port on one-end side and opened and closed by another valve on the other-end side, and a second large diameter passage formed on the outer periphery of the latter valve-opening/closing passage, and directly communicating with the second port and communicating with the latter valve-opening/closing passage by opening of the latter valve; and
a second solenoid valve having assembled to the second piping section a second driving force generating section generating driving force for opening and closing the latter valve,
wherein a communication section between the common first port, the valve-opening/closing passage, and the third port in the first piping section is formed such that the diameter of the communication section is larger than the inner diameter of the valve-opening/closing passage bypassing the communication section through the first piping section from the external; and
wherein the communication section includes a lid sealing a hole formed by the passing therethrough.

3. The flow rate control apparatus according to claim 1, wherein the common first port is formed such that the internal diameter thereof is larger than the internal diameter of the former valve-opening/closing passage, while the common second port is formed such that the internal diameter thereof corresponds to the internal diameter of the common first port.

4. The flow rate control apparatus according to claim 2, wherein the common first port is formed such that the internal diameter thereof is larger than the internal diameter of the former valve-opening/closing passage, while the common second port is formed such that the internal diameter thereof corresponds to the internal diameter of the common first port.

5. The flow rate control apparatus according to claim 1, wherein the first and third ports, and the second and fourth ports are connected with a rubber hose, respectively.

6. The flow rate control apparatus according to claim 2, wherein the first and third ports, and the second and fourth ports are connected with a rubber hose, respectively.

7. The flow rate control apparatus according to claim 1, wherein the first and second ports each include a groove fitting an O ring at the end portion on the outer peripheral surface thereof, and the third and fourth ports each include a large diameter end portion covering the outer peripheral surface of the O ring; and
wherein the large diameter end portion of the third port is connected to the first port, and the large diameter end portion of the fourth port is connected to the second port, respectively, with interposing the O ring in the groove.

8. The flow rate control apparatus according to claim 2, wherein the first port and the second port each include a groove fitting an O ring around the end portion of the outer peripheral surface thereof, and the third port and the fourth port each include a large diameter end portion covering the outer peripheral surface of the O ring; and
wherein the large diameter end portion of the third port is connected to the first port, and the large diameter end portion of the fourth port is connected to the second port, respectively, with interposing the O ring in the groove.

9. The flow rate control apparatus according to claim 1, wherein the first and third ports, and the second and fourth ports are connected by welding, respectively.

10. The flow rate control apparatus according to claim 2, wherein the first and third ports and the second and fourth ports are connected by welding, respectively.
